(19) United States
(12) Patent Application Publication
(10) Pub. No.: US 2011/0040991 A1
(43) Pub. Date: Feb. 17, 2011

(54) Method for power overload control in a network

(75) Inventor: Po-Sheng Wu, Taipei City (TW)

Correspondence Address: BACON & THOMAS, PLLC, 625 SLATERS LANE, FOURTH FLOOR, ALEXANDRIA, VA, 22314-1176, US

(73) Assignee: MOXA INC., Shing Tien City (TW)

(21) Appl. No.: 12/461,485

(22) Filed: Aug. 13, 2009

(51) Int. Cl. G06F 1/00

(52) U.S. Cl. 713/310

(57) ABSTRACT

The present invention relates to a method for power overload control in a network, comprising an Ethernet switching device and a plurality of network powered devices, wherein the Ethernet switching device includes a central processing unit (CPU), a Power-over-Ethernet (PoE) control unit and an Ethernet port. The PoE control unit can regularly check if any of the plurality of network powered devices is overloaded, and in case of any overload, will transmit signals to the CPU, which will further decide on the network powered devices to be selected for disconnection according to the preset conditions for supplying power to avoid interferences over major network powered devices and reduce losses to enterprises effectively. Besides, when the network powered device is disconnected, the CPU will again send warning signals to the computer device, so that managers can be informed of the status of the remote terminals and then reschedule the power supply immediately and eliminate failures quickly.

### BACKGROUND OF THE INVENTION

1. Field of the Invention

The present invention relates to a method for power overload control in a network, in which an Ethernet switching device is used to cut off the power supply to a specific network powered device (PD) in the network to reduce the cases where the major network PD fails in the network and reduce the losses to enterprises in property.

2. Description of the Prior Art

With rapid progress in computer technology, computer devices become widespread in every corner of the society, while quick developments in network technology also open a new chapter in peoples' life, learning, study and entertainment. Under such circumstances, people can contact and communicate with each other by delivering messages among them via a network. Currently, communication of computers with networks is enabled mainly by using components for Ethernet, such as RJ45. However, such network equipments connected with wired Ethernet networks shall usually be powered by external and independent power supplies, for example, computer systems, IP phones, wireless base stations, IP cameras or hubs. As a result, use of these network devices is subject to the position of power supply, and these devices will become useless in the places where power supply is not available. The solution to this issue is the IEEE 802.3af standard for Power over Ethernet (PoE). This technology does not require any change to original Ethernet cabling infrastructure; instead, it only requires a PoE chip to be installed additionally in the original Ethernet device, so that the power can be separated from the Ethernet network for use in places where the power supply is not available.

Since the PoE technology enables electricity of up to 15 W/48V power to be transferred safely and reliably on the network architecture of CAT5, CAT5e and CAT6 cables, it particularly applies to industrial communication applications. Therefore, the PoE capability is widely adopted in existing Ethernet switching devices for industrial use.

In general industrial application environment, the electricity used by Ethernet switching devices often comes from direct current (D/C) power suitable for use in systems, which is transformed by external power supplies from alternating current (A/C) power at site. In another word, power supplies at different levels will supply electricity of different power to Ethernet switching devices. In light of this, how to plan total power consumption for network devices (hereinafter referred to as network powered devices) correctly shall be decided by system planners based on the actual application environment. If user managers “plan” or “operate” the system power of Ethernet switching devices improperly, it may cause total power consumption of the Ethernet switching devices and network powered devices they connect to be larger than the total load power supplied by external power supplies, thus further causing power protection mechanisms to be started, and the power supply to the whole system will be cut off. Afterwards, the system planners will not replan the power supply to restart the system until they find out that the whole system halts. But this approach often causes the system to halt for a long period, and in industrial environments involving production operations, it will delay the production time and cause heavy losses to enterprises' assets. On the other hand, if the power supply to the system is halted suddenly, it may cause working system equipments to fail, thus increasing the risk of damages to enterprises' equipments and maintenance costs.

In light of these situations, an enterprise developed another protection mechanism, as described in the U.S. Pat. No. 7,225,345, to address the above-mentioned issue. Refer to FIG. 6, which clearly shows that the power protection mechanism enables connection of an Ethernet switching device A with a network powered device B via a port C, wherein the Ethernet switching device A comprises a PoE control unit A1 which includes a general-purpose resistor A11 capable of current sensing and error protection and a power converter A12 that is controlled by the general-purpose resistor A11. When sensing that the power for the network powered device B exceeds the original default value, the general-purpose resistor A11 will drive the power converter A12 to cut off the power supply, thus switching off the network powered device B that is overloaded with power. However, while this approach is effective in addressing the aforesaid issue of sudden power outages to avoid the risk of system breakdown, the protection mechanism can only be utilized to switch off the network powered device B which is overloaded with power. If the network powered device B is a major operating facility or important device of an enterprise, such halting will still have impact on and losses to the enterprise.

In addition, if managers cannot be informed of halting of the network powered device B as soon as possible, they will not be aware of the status of the network powered device B, and will not be able to reschedule the electricity supply immediately. If this happens to IP cameras inside banks or factories, the window period makes it easy for outsiders to enter or may result in other disasters.

Thus, how to overcome the aforesaid common problems and disadvantages is just what the firms involved in this industry need urgently to research and improve.

### SUMMARY OF THE INVENTION

In view of the aforesaid problems and disadvantages, the inventor has collected related information, conducted assessments and taken considerations in many aspects, and based on his own experience of many years in this industry, has finally invented the method for power overload control in a network following continuous trials and corrections.

The primary object of the present invention is to utilize an Ethernet switching device that is capable of controlling total power consumption of network powered devices to ensure that the total power consumption does not exceed the total power supplied by an external power source to the network powered devices, thus preventing shut-off of power supply to the whole operating system in an enterprise and further preventing halting of production. This method employs a PoE control unit in the Ethernet switching device to detect network powered devices regularly. When detecting any power overload on network powered devices, the PoE control unit will send signals to a central processing unit (CPU), which decides which of the network powered devices needs to be switched off based on the preset conditions for power supply, followed by sending alarm signals to computer devices. In this way, managers can be informed immediately, which also helps reduce the risks caused by the window period due to failure of the network powered devices effectively, and by selecting a specific network powered device and switching it off, this method is effective to avoid halting of major network powered devices.

The secondary object of the present invention is to make it convenient for managers to plan and control power supply to the network powered devices by using the Ethernet switching device through graphical interfaces displayed in the computer devices. Thus it is not necessary for the managers to spend time in learning complicated programming language, and it can also reduce the risk of causing the system to fail due to input of incorrect programming language.

### BRIEF DESCRIPTION OF THE DRAWINGS

FIG. 1 is a block diagram illustrating the method for power overload control in a network disclosed in the present invention.

FIG. 2 shows a block diagram illustrating another example of the preferred embodiment of the present invention.

FIG. 3 shows a flow chart for the method for power overload control in a network disclosed in the present invention.

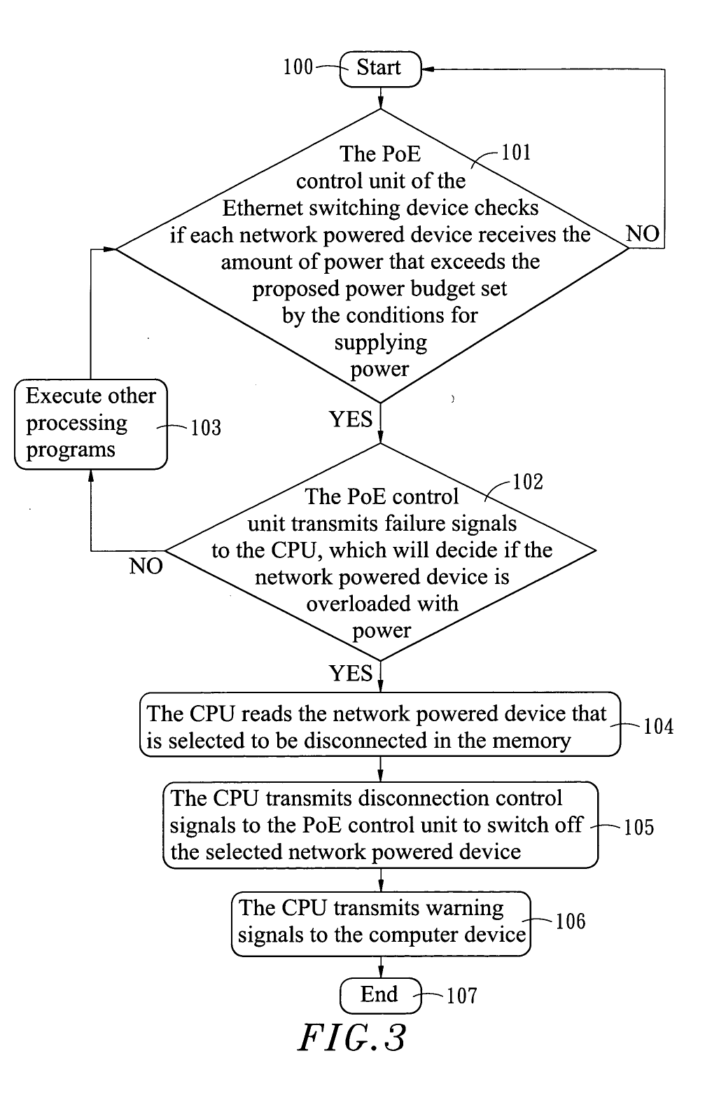

FIG. 4 schematically shows an operation picture according to an example of the preferred embodiment of the present invention.

FIG. 5 schematically shows receiving alarm signals by a computer device according to an example of the preferred embodiment of the present invention.

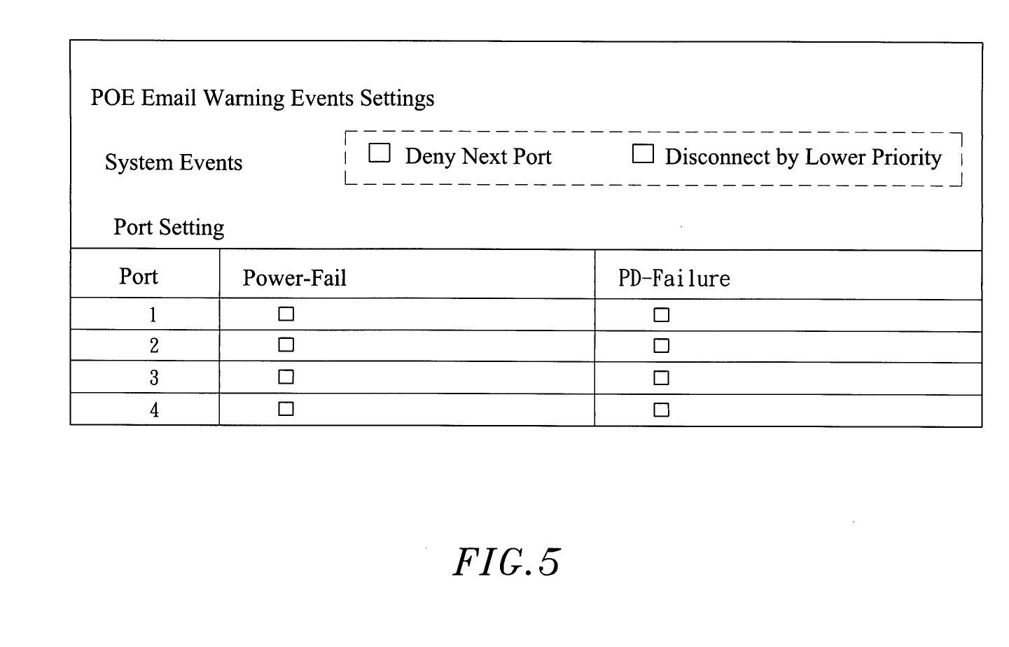

FIG. 6 is a block diagram illustrating a conventional method for power overload control.

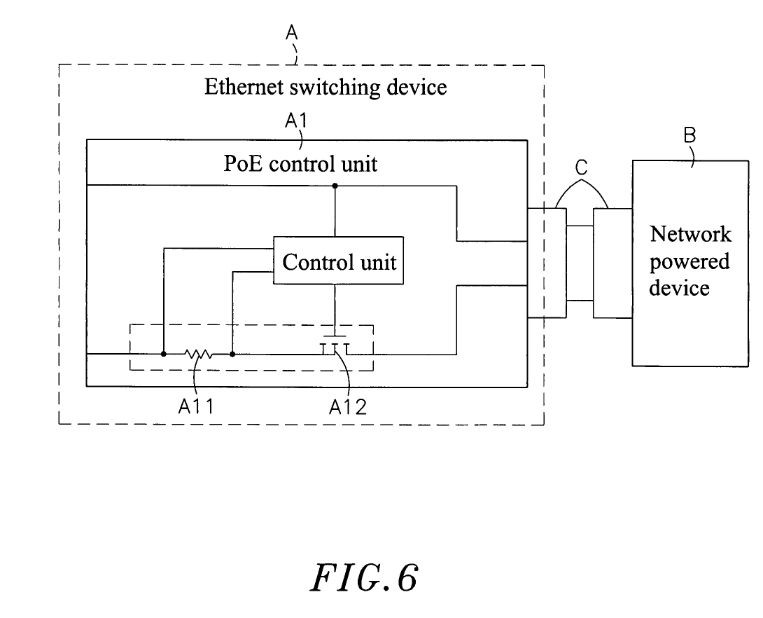

### DETAIL DESCRIPTION OF THE INVENTION

To achieve the aforesaid objects and functions as well as the techniques applied in the present invention and its fabrication, an example of the preferred embodiment of the present invention is given to describe the features and functions of the present invention in detail by referring to the accompanying drawings.

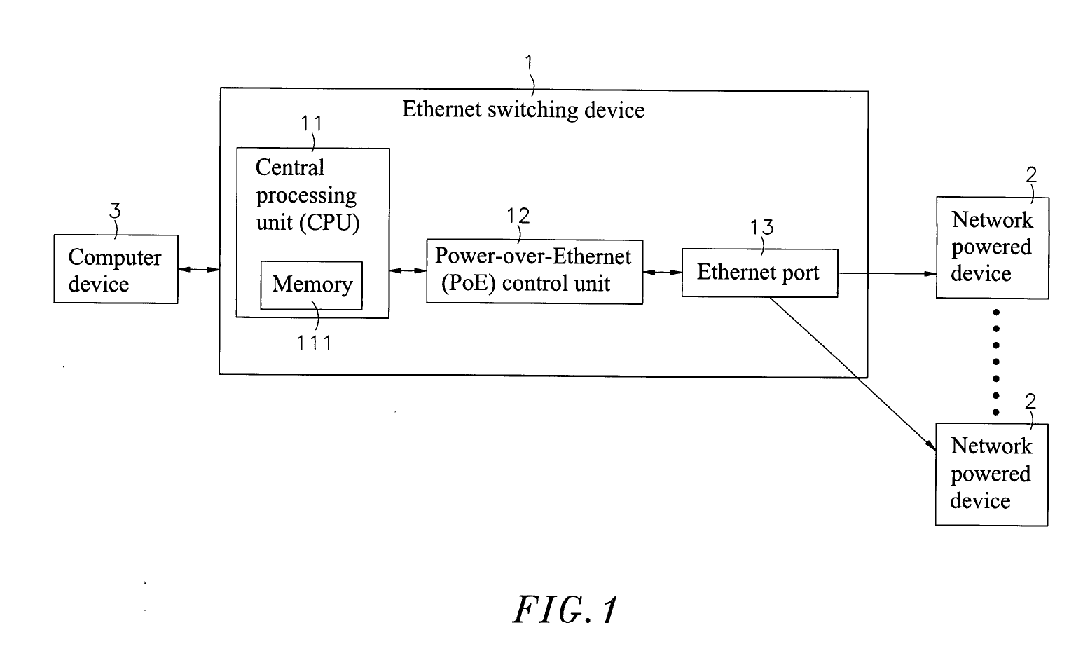

Refer to FIG. 1, which clearly shows that the present invention comprises an Ethernet switching device 1, a network powered device 2 and a computer device 3, wherein:

The Ethernet switching device 1 includes a central processing unit (CPU) 11, which has a memory 111 inside and is connected with a Power-over-Ethernet (PoE) control unit 12 that is further linked with an Ethernet port 13. The Ethernet port 13 may be an RJ45 or a component for Ethernet connection in any other form, and one or more Ethernet ports 13 can be equipped. The CPU 11, the PoE control unit 12 and the Ethernet port 13 are installed in a proposed electronic circuit module of the Ethernet switching device 1 (not indicated in the figure).

The network powered device 2 is connected via Ethernet cables with the Ethernet port 13 of the Ethernet switching device 1, and it may be a computer system, an IP phone, a wireless base station, an IP camera or hub. And there may be two or more network powered devices 2.

The computer device 3 is connected with the CPU 11 in the Ethernet switching device 1, and may be a notebook computer, an industrial computer, a desktop computer or a server, etc.

Refer to FIGS. 1 & 3, which show clearly that the computer device 3 can set the conditions for supplying power in the Ethernet switching device 1, and the Ethernet switching device 1 can store these conditions into the memory 111 of the CPU 11. These conditions for supplying power may include the budget of power supplied by the Ethernet switching device 1, power limits on the network powered devices 2, and the network powered device 2 to be selected for disconnection in case of overload, etc. The handling process is as follows:
(100) Start
(101) The PoE control unit 12 of the Ethernet switching device 1 checks if each network powered device 2 receives the amount of power that exceeds the proposed power budget set by the conditions for supplying power through the Ethernet port 13. If not, proceed to step (100); and if so, proceed to step (102).
(102) The PoE control unit 12 transmits failure signals to the CPU 11, which will decide if the network powered device 2 is overloaded with power. If not, proceed to step (103); otherwise, proceed to step (104).
(103) Execute other processing programs and proceed to step (101).
(104) The CPU 11 reads the network powered device 2 that is selected to be disconnected in the memory 111.
(105) The CPU 11 transmits disconnection control signals to the PoE control unit 12, which will switch off the selected network powered device 2.
(106) The CPU 11 transmits warning signals to the computer device 3.
(107) End.

Other handling processes mentioned in the above section may apply to the network powered device 2 that fails or to other situations.

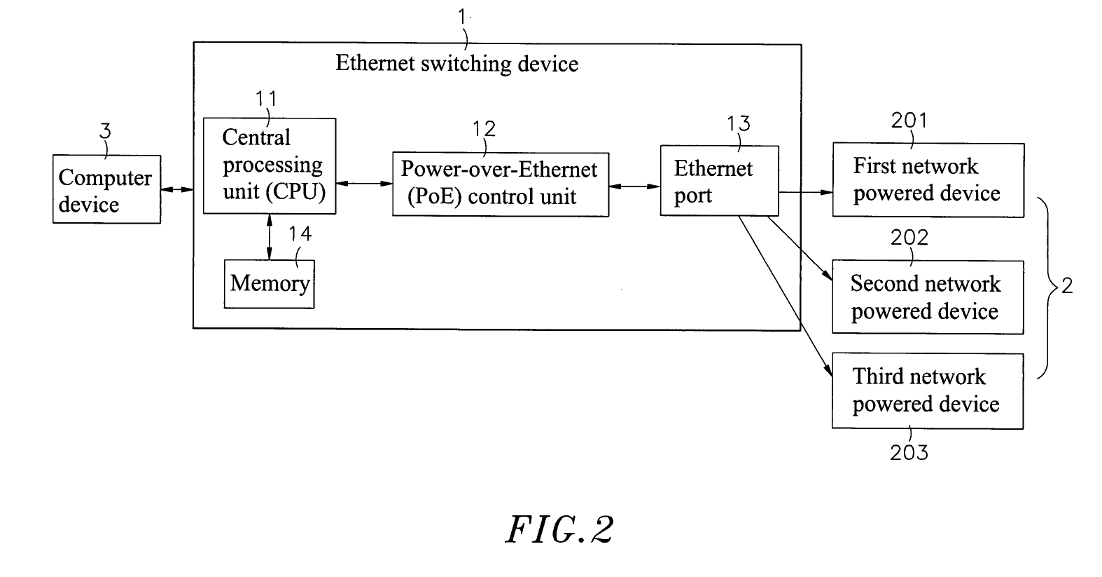

Since the Ethernet switching device 1 can be connected with a plurality of network powered devices 2 which may constitute essential or auxiliary equipments of an enterprise, wherein the essential production equipments are important operating resources of the enterprise, and the auxiliary equipments are used to support corporate operations. When the essential equipments fail to work, it will cause more severe impact on the enterprise than the auxiliary equipments. So when the amount of power used by the plurality of the network powered devices 2 is more than that of power that can be supplied by the Ethernet switching device 1, managers can disconnect the auxiliary network powered devices 2 without interfering with the essential network powered devices 2 by using this method. In the present invention, three network powered devices 2 are taken as an example. Yet the quantity of the network powered devices 2 may be two or more, and the change in number of the network powered devices as well as whether the memory 111 is included in the CPU 11 shall not be construed as limiting the appended patent claims of the present invention. Turn to FIGS. 2˜3, which show clearly that the present invention comprises a first network powered device 201, a second network powered device 202 and a third network powered device 203 according to the example of one embodiment. Suppose that the first network powered device 201 and second network powered device 202 is major facilities of an enterprise (e.g. monitoring equipments in a major factory), and that the third network powered device 203 is an auxiliary device (e.g. a monitoring device in a subordinate factory) and the CPU 11 is electrically connected with a memory 14 and transmits signals between them. Managers can use the computer device 3 to set a higher priority on the first and second network powered devices 201 and 202, and set a lower priority on the third network powered devices 203, and then save these settings in the memory 14. When the PoE control unit 12 of the Ethernet switching device 1 detects current overloads on the network powered device 2 via the Ethernet port 13, it will read the data in the memory 14 by using the CPU 11 and power off the third network powered device 203 with a lower priority. So the power supply to the third network powered device 203 will be halted. At the same time, the CPU 11 will send warning signals the computer device 3 so as to inform the managers to reschedule the power supply to the system.

On the other hand, the Ethernet switching device 1 includes a plurality of the Ethernet ports 13, which can be used by the managers to connect the network powered devices 2 with the Ethernet switching device 1 according to their needs. In general, the sequence of connection is related to importance of corporate operations. That is to say, the more important the equipment is, the earlier it will be connected with the Ethernet switching device 1. Thus, the managers can also decide on the last network powered device 2 to be connected with the Ethernet switching device 1 in case of power overload, namely, the last network powered device 2 that cause the system to be overloaded will be selected for disconnection. The managers can decide to select the network powered device 2 with a lower priority or the last one that cause the system to be overloaded for disconnection according to the actual status of working. However, any of the above options can prevent the major network powered device 2 connected with the Ethernet switching device 1 from being impacted, thus mitigating the losses to an enterprise due to halting of the network powered device 2.

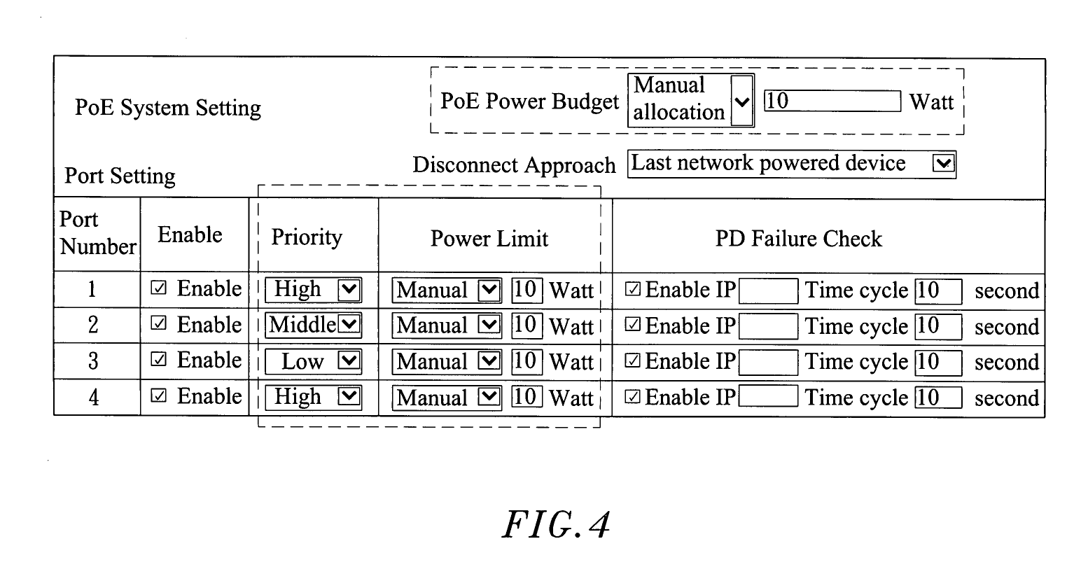

Further refer to FIGS. 4˜5, which show clearly that the computer device 3 has a graphical operation interface which can exercise control over the Ethernet switching device 1. These figures show the Ethernet switching device 1 that include a plurality of the Ethernet ports 13, and the managers can implement settings of related information at their own discretion. For example, they may select to set the PoE Power Budget, priority of individual the network powered devices 2 and Power Limit for each network powered device 2, or may select to execute Disconnect Approach. They may select “Disconnect by Lower Priority” or “Deny Next Port”, which means that the last network powered device 2 that cause the Ethernet switching device 1 to be overloaded is selected to be disconnected, and such information can be set additionally according to designers' needs. On the other hand, after the Ethernet switching device 1 is overloaded and further disconnected as a result, it will notify the computer device 3 of such disconnection via email, and will immediately inform managers of working status of the plurality of the network powered devices 2 by providing a list. However, the alarms can be given by sending SNMP Trap or active messages in addition to emails and these descriptions are given only to illustrate one example of the preferred embodiment of the present invention, and shall not be construed as a limitation on the scope of the appended claims of the present invention. It is hereby declared that all modifications and equivalent structural changes made on the basis of the descriptions and drawings given in the present invention shall be included in the patent claims of the present invention.

The descriptions in the preceding sections are given to illustrate an example of the preferred embodiment of the present invention. However, these descriptions shall not be construed as limiting the scope of the patent claims of the present invention. All information mentioned in this paper, including the number of the network powered devices 2, ways to give warnings, design of graphical interfaces, whether the memory 111 is installed in the CPU 11 and so on, is subject to setting or change by managers at their own discretion. The major characteristics of the present invention lie in the capability of the Ethernet switching device 1 to check and determine if the network powered device 2 is overloaded with power and the technique to disconnect a selected network powered device 2 in case of overload in order to prevent the major network powered device 2 from being halted. Therefore, all modifications and equivalent structural changes made without departing from the spirit of the art and scope disclosed in the present invention shall be included in the patent claims of the present invention.

To sum up, when applied, the method for power overload control in a network as disclosed in the present invention has the advantages as follows:

(1) The technique adopted in the present invention to disconnect a selected network powered device 2 can assist enterprises in reducing interferences over their major operating facilities. When the Ethernet switching device 1 detects any overload on the network powered device 2, it will select to disconnect the network powered device 2 with lower priority or the last one that is overloaded. In this way, disconnection of the major network powered device 2 can be avoided effectively.

(2) The present invention can ensure that when the network powered device 2 is halted, the CPU 11 will deliver warning messages to the computer device 3, so that system planners can be informed immediately and take measures to rapidly reschedule the system power, thus allowing enterprises to quickly restore their operations.

(3) The present invention employs graphical ports to facilitate operation by manager in a humanized way. Such approach will help prevent the potential risk of system failure due to incorrect input of complex programming language, and avoid spending additional time in learning how to operate the device.

To summarize the descriptions given above, the method for power overload control in a network disclosed in the present invention, once applied, will achieve functional improvements obviously. Therefore, the present invention really satisfies conditions for patentability of an invention. While the application of patent is filed pursuant to applicable laws, your early approval of the present invention will be highly appreciated so as to guarantee benefits and rights of the inventor who has worked hard at this invention. For any question, please do not hesitate to inform the inventor by mail, and the inventor will try his best to cooperate with you.

What the invention claimed is:

1. A method for power overload control in a network, more particularly, the method for controlling power consumption of a plurality of network powered devices by an Ethernet switching device which is connected with two or more network powered devices; the handing process of the method is as follows:
(A) start;
(B) a Power-over-Ethernet (PoE) control unit of the Ethernet switching device checks if any network powered device is overloaded with the power that exceeds the power budget preset by the conditions for supplying power through an Ethernet port; if not, proceed to step (A); and if so, proceed to step (C);
(C) the PoE control unit transmits failure signals to a central processing unit (CPU), which will decide if the network powered device is overloaded with power; if not, proceed to step (B); otherwise, proceed to step (D);
(D) the CPU delivers disconnection control signals to the PoE control unit based on the conditions for disconnecting a proposed network powered device;
(E) the PoE control unit disconnects a proposed network powered device after receiving the disconnection control signals from the CPU.

2. The method for power overload control in a network according to claim 1, wherein the conditions for disconnecting the network powered device cover the network powered device with lower priority or the network powered device that is overloaded at last.

3. The method for power overload control in a network according to claim 1, wherein the CPU will transmit warning signals to a proposed computer device when it detects any overload on the network powered device.

4. The method for power overload control in a network according to claim 1, wherein the network powered device may be a computer system, an IP phone, a wireless base station, an IP camera or a hub.

5. The method for power overload control in a network according to claim 1, wherein the Ethernet port is a component for Ethernet connection.

6. The method for power overload control in a network according to claim 1, wherein the computer device has graphical operation ports, which include such information as proposed power budget, priority of each network powered device and proposed amount of power for each network powered device.

7. The method for power overload control in a network according to claim 1, wherein the CPU of the Ethernet switching device transmits warning signals to the computer device via emails, SNMP traps or active messages.

8. The method for power overload control in a network according to claim 1, wherein the disconnecting conditions are stored in a memory of the CPU for the proposed network powered device.

9. The method for power overload control in a network according to claim 1, wherein the disconnecting conditions are stored in a memory connected with the CPU electrically for the proposed network powered device.
